(19) United States
(12) Patent Application Publication
(10) Pub. No.: US 2025/0245937 A1
(43) Pub. Date: Jul. 31, 2025

(54) OBJECT SCANNING WITH DYNAMIC GUIDANCE

(71) Applicant: Niantic, Inc., San Francisco, CA (US)

(72) Inventors: Jessica Van Brummelen, London (GB); Gabriel Brostow, London (GB); Mohamed Amr Abdelfattah Sayed, London (GB); Charles Fletcher Houseago, London (GB)

(21) Appl. No.: 19/038,575

(22) Filed: Jan. 27, 2025

Related U.S. Application Data
(60) Provisional application No. 63/625,910, filed on Jan. 26, 2024.

(51) Int. Cl. G06T 19/00

(52) U.S. Cl. CPC G06T 19/006

(57) ABSTRACT

A user selects an object on the display of a mobile device and a corresponding coordinate in a 3D map including the object is selected. A bounding volume and center point of the object in 3D space is estimated based on segmenting the image to identify the object and the depth of pixels in the segmented region depicting the object. The user follows an approximately circular path around the object, pointing a camera at the object, and receives audio and/or haptic feedback regarding orientation of the camera, distance from the object, or speed of progression along the path. As the user moves the camera, a 3D scan of the object is generated. The center point of the object may be recalculated as the user progresses along the path.

### 1. TECHNICAL FIELD

The subject matter described relates generally to augmented reality, and, in particular, to improved process for obtaining three dimensional (3D) scans of objects.

### 2. PROBLEM

People are increasingly using smartphones to scan objects and landmarks. On one hand, users have intrinsic motivations to scan well (e.g., keeping the object in-frame while walking around it to achieve coverage). On the other, users may lack motivation to scan well due to losing interest when filming inanimate objects, feel rushed in public, or seek to avoid attention from passerby's, etc. Furthermore, it can be difficult for users to determine the quality of the scans they are producing and when those scans are complete (e.g., sufficiently detailed, providing coverage of the entire object, etc.).

Augmented reality (AR) content provided to users based on the scans may exhibit immersion-breaking artifacts. For example, if the intent is for a virtual bracelet to be on a statues arm, a poor-quality scan may result in the bracelet being rendered as passing through the arm of the statue, or even floating in space to the side of the statue. Producing poor quality scans may also disincentivize users from creating further scans. Thus, there is a need for a system and method for consistent creation of high-quality 3D scans of environments.

### SUMMARY

The present disclosure describes approaches to scanning objects that use various forms of dynamic guidance to direct the user in efficiently obtaining high-quality scans of objects. Image segmentation may be used to aid the user in selecting an object to scan and then dynamic guidance provided to guide the user in changing the location and orientation (collectively “pose”) of a camera to scan the object. In one embodiment, the guidance is provided for three metrics: distance from the object, orientation of the camera (keeping the object in view), and speed of motion of the camera. The guidance may be provided using any combination of on-screen indicators, haptic indicators, and audio indicators and may be provided in real-time as the user scans the object with the camera.

In one embodiment, a method of scanning objects comprises receiving images of the object from a client device. The method continues with estimating a bound volume around the object in the images and providing, to a client device, guidance of how to move around the object based on the bounding volume. The method continues with receiving data describing the movement of the client device and determining that an aspect of the movement is not correct for scanning the object. The method continues with providing feedback that indicates what movement needs to be changed for proper scanning.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for providing dynamic guidance for scanning objects, according to one embodiment.

FIG. 4 is a block diagram of the scanning subsystem shown in FIG. 3, according to one embodiment.

FIG. 5A is an example user interface depicting scanning of an object from a first view, according to one embodiment.

FIG. 5B is an example user interface depicting scanning of an object from a second view, according to one embodiment.

FIG. 6 is a flowchart of a process for scanning an object with dynamic guidance, according to one embodiment.

FIG. 7 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments of 3D object scanning are described in the context of a parallel reality game that includes augmented reality content in a virtual world geography that parallels at least a portion of the real-world geography such that player movement and actions in the real-world affect actions in the virtual world. The subject matter described is applicable in other situations where obtaining 3D scans of objects is desirable. In addition, the inherent flexibility of computer-based systems allows for a great variety of possible configurations, combinations, and divisions of tasks and functionality between and among the components of the system.

### Example Location-Based Parallel Reality Game

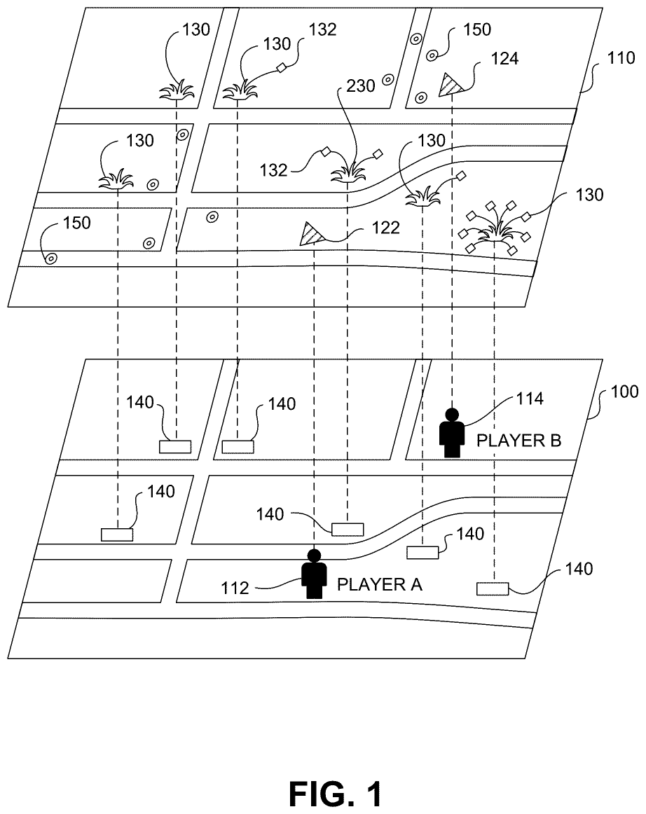

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

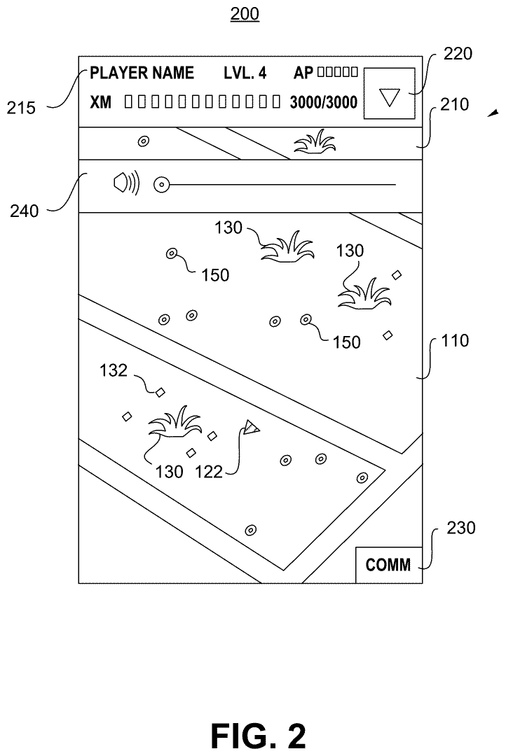

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

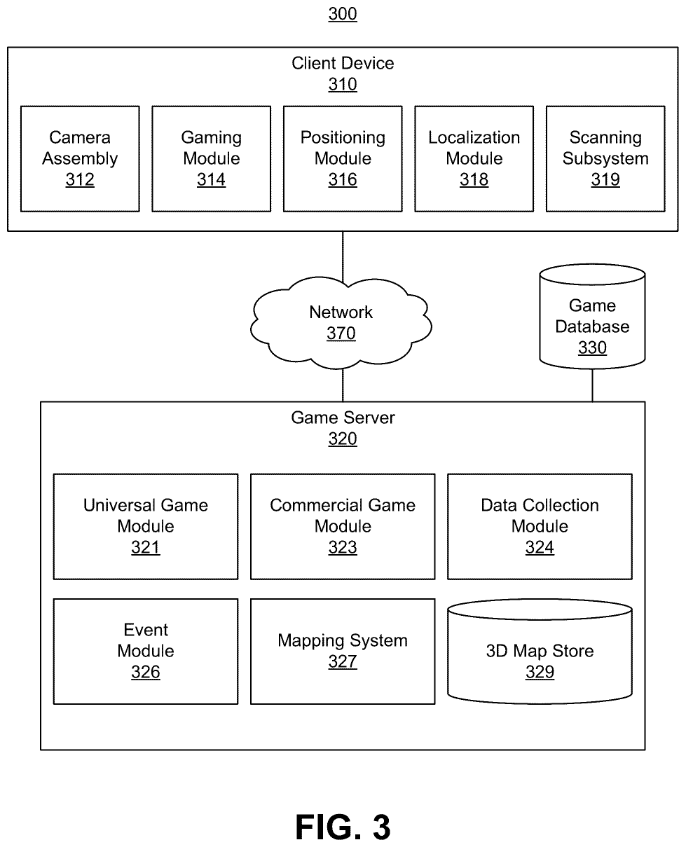

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, a localization module 318, and a scanning subsystem 319. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The scanning subsystem 319 provides a user interface on a user's client device 310 that guides the user to scan an object (e.g., a landmark). The scanning subsystem obtains one or more images or videos from the camera assembly 312, and the user selects an object to scan that is depicted in at least some of the image data. The one or more images can be frames of a video and are henceforth referred to as “images” for simplicity. In one embodiment, image segmentation is used to identify objects in the images and indicates which pixels correspond to different objects within the images. For example, the scanning subsystem 319 may cause the user interface to depict the images with objects highlighted within the image, e.g., by outlining the pixels representing each object, overlaying bounding boxes around pixels representing each object, changing a color scheme of the pixels representing each object, etc. The user selects an object to scan by tapping on or otherwise selecting one or more pixels that the image segmentation indicates are part of the object.

The scanning subsystem 319 causes dynamic guidance for scanning the object to be provided to the user. The dynamic guidance may be based on additional images captured by the camera assembly 312 of the object and directs the user to traverse a specified path around the object while pointing one or more cameras of the camera assembly 312 at the object. For example, the dynamic guidance may include a path overlaid on real-time images of the object showing the user where to traverse while scanning the object. The dynamic guidance may also include audio or haptic feedback that corresponds to the path. For example, the dynamic guidance may provide a first vibration pattern or sound when the user is on the path and a second vibration pattern or sound when the user is off the path.

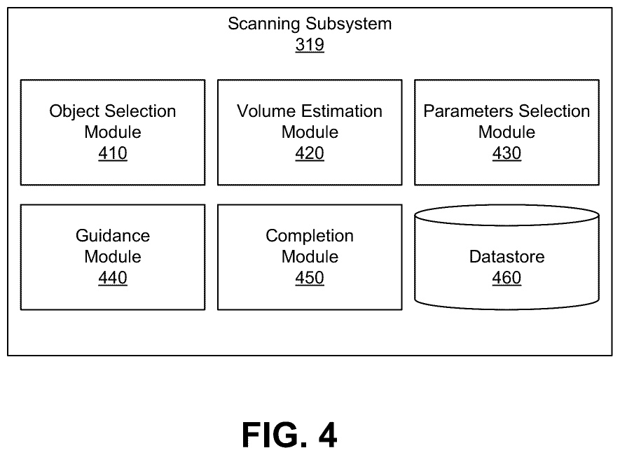

The guidance may also provide feedback on the speed at which the user is moving their client device 310 to encourage the user to move the client device at a speed that is conducive to obtaining high-quality scans. Various embodiments of the scanning subsystem 319 are described in greater detail below, with reference to FIG. 4. Note that although the scanning subsystem 319 is shown as part of a client device 310, some or all of the functionality of the scanning subsystem may be performed by another computing device, such as the game server 320 (which may provide the scanning functionality as a service with the client device 310 capturing and providing images and receiving instructions for guidance to provide to the user).

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

FIG. 4 illustrates one embodiment of the scanning subsystem 319. In the embodiment shown, the scanning subsystem 319 includes an object selection module 410, a volume estimation module 420, a parameters selection module 430, a guidance module 440, a completion module 450, and a datastore 460. In other embodiments, the scanning subsystem 319 may include different or additional components. Furthermore, the functionality may be distributed between components differently than described.

The object selection module 410 provides an interface for the user to select an object to scan. In one embodiment, the object selection module 410 causes a display of the client device 310 to show images captured by the camera assembly 312 substantially in real time. The images may depict an environment that includes one or more objects that are candidates to be scanned. The user may select an object to scan by tapping or otherwise selecting it in a displayed image that depicts the object. The object selection module 410 may use image segmentation to identify pixels corresponding to one or more objects depicted in images. The image segmentation may be applied to images in advance or in response to the user attempting to select an object. In either case, once image segmentation has been used to assign pixels to objects, an object may be selected by determining the object that corresponds to a pixel tapped on or otherwise selected by the user.

The volume estimation module 420 places a 3D bounding box around a selected object in a 3D map generated for the environment that includes the selected object. Note that although the term “bounding box” is used, the volume estimation module 420 may determine a volume of any shape that surrounds the selected object. The extent of the bounding box in the two dimensions of the plane of the image from which the object was selected may be determined from the image segmentation. The extent of the bounding box in the third dimension (i.e., depth) may be initially determined by estimating pixel depths (i.e., distance between the camera and the pixel) for pixels that are segmented as corresponding to the object and selecting minimum and maximum values based on the pixel depths, such as the minimum and maximum estimated depths for pixels, the minimum and maximum estimated depths after removing outliers, a set proportion (e.g., 95%) of the minimum and maximum depths, etc. As additional images depicting the object are obtained, some or all of these additional images may also be segmented to identify the object and the volume estimation module 420 may update the extent of the 3D bounding box to better correspond to the object. For example, if images depicting the object captured from another angle indicate that it extends further in one direction than could be seen in the originally captured image(s) then the bounding box may be extended in that direction to fully encompass the object in view of the additional information available from the new images.

The parameters selection module 430 selects parameters for the scan of the object. In one embodiment, the parameters include one or more of the shape of the path to be taken, a distance (or distances) from the object the client device 310 should be while scanning, or the speed at which the client device 310 should be moved during scanning. The parameters may be predetermined, derived from one or more captured images, or a combination of both. In one embodiment, the path to be taken is a circle centered on the object. The radius of the circle (i.e., the distance to the object) may be a predetermined distance, an estimated initial distance between the client device 310 and the object based on the captured images, or a distance determined based on the size of the object (e.g., selected so that the object fills a target proportion of captured images). Alternatively, the path may be an arc centered on the object. For example, if the object is a mural or some other two-dimensional object, or available map data otherwise indicate that it is impossible or impractical for the user to traverse a full circle around the object, the parameters selection module 430 may define a path that is a portion of a circle around the object (e.g., 150 degrees). The speed for the user to move the client device 310 may be predetermined (e.g., optimized to provide high-quality scans), based on user preferences, determined from contextual data (e.g., if the object is in a busy area, a higher speed may be selected to reduce the impact of people disrupting the scan versus in a quiet area using a lower speed to obtain higher-quality scan data), or selected using any other suitable technique.

The guidance module 440 causes the client device 310 to present guidance to the user in following the path determined by the parameters selection module 430. The guidance module 440 receives sensor data from the client device 310 that describes movement of the client device 310 during scanning. In one embodiment, the guidance module 440 uses the sensor data to determine a real-time location of the client device 310 in the real world and uses the location or sensor data to determine three metrics: the distance between the client device 310 and the object, the orientation of the client device relative to the object, and the speed at which the client device is being moved. The guidance module 440 may determine whether the client device 310 has deviated or will deviate from the parameters based on these metrics. The guidance module 440 may also determine how the client device 310 needs to move to meet the parameters based on the metrics and provide feedback to the client device 310 to guide the user to stay on the path. The guidance can be provided by visual feedback presented on a display of the client device 310 (e.g., overlaid on the images being captured during scanning), haptic feedback, audio feedback, or a combination thereof.

In one embodiment, visual indicia overlaid on images being captured by the camera assembly 312 are used to guide the user. A path to follow may be indicated by an AR track overlaid on the images. Deviations from the target orientation of the device may be indicated by text or arrows directing the user to modify the orientation of the client device 310. For example, an arrow may be overlaid on the images being captured by the camera assembly 312 indicating the direction in which the camera should be rotated to improve its orientation, with a visual property of the arrow (e.g., a size or intensity) indicating how much rotation is desirable. Similarly, deviations from the target speed may be indicated by a text notification prompting the user to speed up or slow down.

In another embodiment, a combination of audio and haptic feedback may be used to guide the user. Music or other audio may be played continuously with properties of the audio being modified to guide the user. For example, the tempo, average pitch, volume, or degree of distortion of music may be modified to indicate that the user is too far away from or too close to the object (e.g., the tempo and pitch may increase as the user gets closer and decrease as the user moves further away, with the volume decreasing with the distance from the desired path the user is currently located). The change in properties of the music may be linear with the deviation between the desired distance and the actual distance or scale using any other suitable relationship (e.g., logarithmic such that small deviations do not have a huge impact but larger deviations are quickly apparent to the user).

Haptic feedback may be used to indicate that the orientation of the client device 310 is deviating from what is desired. For example, there may be no feedback if the orientation is within a threshold amount (e.g., number of degrees) from the desired orientation and may then increase (e.g., linearly or logarithmically, etc.) as the actual orientation deviates from the desired deviation by an increasing amount. Differences between the user's speed and the desired speed (e.g., if the user's speed drops below or increases above corresponding thresholds) may be indicated by playing an audio message asking the user to speed up or slow down, respectively. It should be appreciated that numerous other combinations of visual, audio, and haptic feedback may be combined to guide the user with regard to three metrics of the scan: distance, orientation, and speed.

The completion module 450 determines when the user has completed the scan and stores the resulting scan (e.g., in the datastore 460). The scan may be complete when the user has completed one complete rotation around the object (or one traversal of the AR track where less than a full circle is used) or when one or more data metrics are met (e.g., the completion module 450 detects that changes in a 3D model of the object that resulted from a previous set of captured images were less than a threshold amount). In some embodiments, the completion module 450 may monitor the percentage of the scan that has been completed and provide feedback to the user (e.g., a progress bar, percentage amount, or the like) indicating how much of the scan has been completed.

In one embodiment, the completion module 450 identifies a set of checkpoints around the path to be followed. For example, a circular path may be divided into n equal portions, with each checkpoint being 360/n degrees apart. The first checkpoint may be set as the user's starting location and then, as the user moves, the user's direction around the track may be determined and the next checkpoint in that direction selected. The user's position (e.g., angular position along the path) may then be periodically determined and if the user is at or has passed the next checkpoint in the user's direction of travel, that checkpoint may be marked as complete and the scan progress updated. For example, if ten checkpoints are used, each checkpoint that is completed may update the user's progress by 10% and the progress indicator provided to the user may be updated accordingly.

The datastore 460 is one or more non-transitory computer-readable media that store data used by the scanning subsystem 319. For example, the datastore 460 may store one or more of parameters to be used, images captured during scans, or 3D models of objects generated by scans, etc.

In some embodiments, images used by the scanning subsystem 319 are processed to remove potentially sensitive information, such as to anonymize people that are in the vicinity of the object being scanned. For example, an algorithm may be used to detect faces, license plates, and/or other sensitive information and automatically apply a non-reversable blur to these portions of the images.

### Example User Interfaces

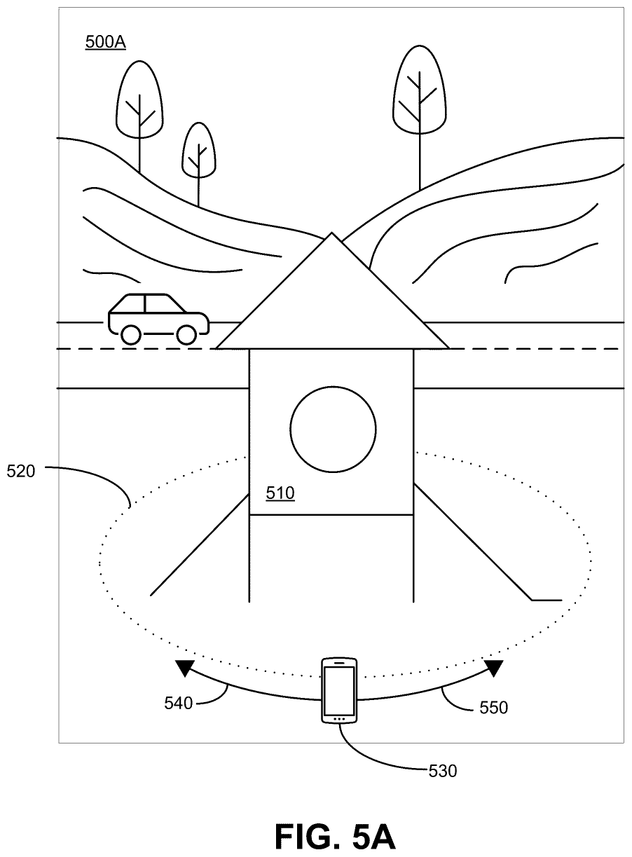

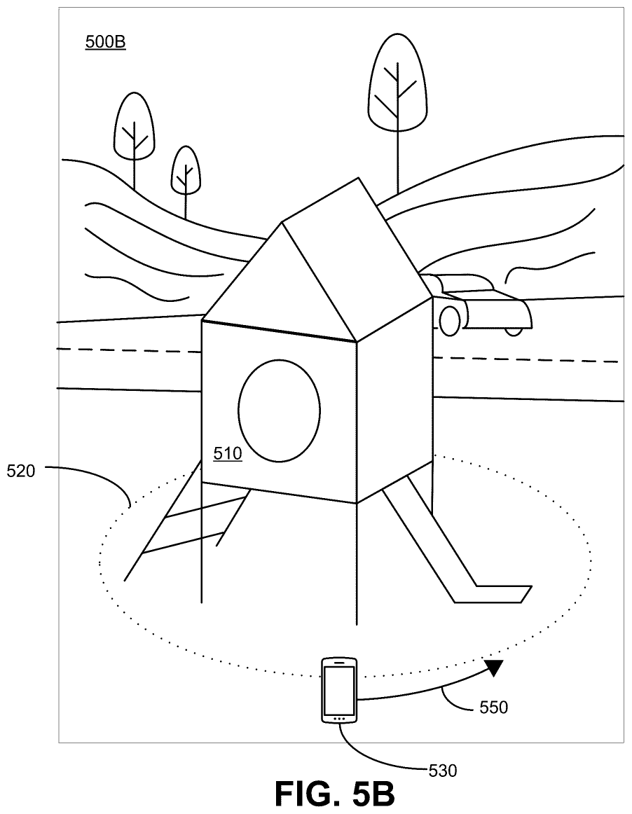

FIG. 5A is an example user interface 500A depicting scanning of an object from a first view, according to one embodiment. The user interface 500A depicts an image of a playground 510 in a field in front of a road and hills and is presented at a client device 310 operated by a user. The playground 510 is surrounded by a bounding circle 520 (also referred to as a bounding box) indicating a border of a volume that encompasses the playground 510. The user interface 500A also includes guidance elements that illustrate to the user how to move the client device 310 to scan the playground. For example, the guidance elements may direct the user to move at a particular distance and angle relative to the playground 510 or to move along the bounding circle 520. In the example user interface 500A, the guidance elements include a client device element 530 that represents the client device 310 and a left arrow 540 and a right arrow 550 showing directions for the client device 310 to move in while scanning the playground 510.

In some embodiments, the client device 310 additionally or alternatively outputs audio and/or haptic guidance as the user moves to guide the user in scanning the playground 510. The audio guidance may be a verbal description of guidance (e.g., “move to the right in around the playground”) or may provide different sounds to indicate if the user is in the correct position for scanning, as determined by the scanning subsystem 319. For example, the client device 310 may emit pleasing tones when the user is moving the client device 310 along the path and annoying tones when the user moves the client device 310 off the path. The haptic guidance may be vibrations, motions, or forces that create a sense of touch or movement for the user when moving the client device 310. For example, the client device 310 may vibrate rapidly when the user moves the client device 310 more or less than a threshold amount away from an optimal scanning distance.

FIG. 5B is an example user interface 500B depicting scanning of an object from a second view, according to one embodiment. The user moved the client device 310 to the right from the first view shown in FIG. 5A, so the user interface 500B is directing the user with the right arrow 550 to continue moving to the right along the bounding circle 520. In some embodiments, the client device 310 may continue to output audio and/or haptic feedback to guide the user the rest of the way around the playground 510. For example, the client device 310 may vibrate and output a loud song when the user moves the client device too close to the playground for scanning (e.g., such that the bounding circle is not entirely visible on the user interface 500B) and output quiet classical music when the user is moving along the bounding circle.

### EXAMPLE METHODS

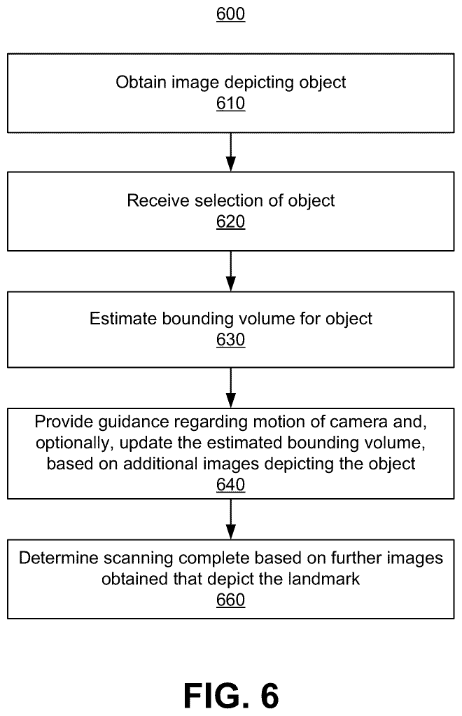

FIG. 6 is a flowchart describing an example method 600 of scanning an object with dynamic guidance, according to one embodiment. The steps of FIG. 6 are illustrated from the perspective of the scanning subsystem 319 performing the method 600. However, some or all of the steps may be performed by other entities or components. In addition, some embodiments may perform the steps in parallel, perform the steps in different orders, or perform different steps

In the embodiment shown, the method 600 begins with the scanning subsystem 319 obtaining an image depicting an object and receiving 620 a selection of the object. As described previously, image segmentation may be used to identify potential objects to be scanned and the object may be selected by the user tapping on or otherwise selecting the object in the image. The scanning subsystem 319 estimates 630 a bounding box for the object and provides 640 guidance regarding motion of the camera of the client device 310 around the object based on further images depicting the object captured by a camera of the client device 310. The guidance can provide feedback indicating how closely the user's motion of the client device 310 matches a desired path with regard to three metrics: distance, orientation, and speed. In some embodiments, the scanning subsystem 319 periodically, continuously, or in response to a triggering condition updates the estimated bounding box for the object based on additional images of the object. For example, as the user moves around the object and more information about the shape of the object becomes available, the bounding box can be updated to more accurately reflect the shape and position of the object. At some point, the scanning subsystem 319 determine 650 that the scanning is complete based on further images of the object captured by the camera. For example, the scan may be determined 650 to be complete when the user has finished traversing a desired path with the camera.

The scan may be used to build a three-dimensional virtual representation (e.g., map or mesh) that may be used in providing AR content. For example, AR characters may be shown sitting on or hiding behind the object, and AR objects may be shown sitting on top of the object, etc. It should be appreciated that having an accurate 3D map of an object enables a wide range of AR content to be presented that appears to interact with the object in various ways.

In some embodiments, the scanning subsystem 319 receives additional images of the object. The additional images may depict the object from one or more different angles and/or distances than the images. The scanning subsystem 319 may update the bounding volume based on its understanding of the shape, size, and volume of the object itself as determined by the additional images. The scanning subsystem 319 may update the guidance to account for the updated bounding volume. For example, if the scanning subsystem 319 expanded the bounding volume based on the additional images, the scanning subsystem 319 may update the desired path to be a further a distance from a center of the bounding volume. In another example, the scanning subsystem 319 may update the desired path to a new shape (e.g., from a circle to an oval, from a square to a trapezoid, etc.) to account for the updated bounding volume.

In some embodiments, the scanning subsystem 319 provides a user interface depicting the images to the client device 310. The scanning subsystem 319 may include a set of interactive elements overlaid on the images in the user interface. The interactive elements may be configured to receive interactions from a user indicative of one or more objects to scan. For example, the interactive elements may be a grid overlaid on the images. The scanning subsystem 319 may determine an object for scanning based on the locations within the grid of the interactive elements that received interactions. In some embodiments, the scanning subsystem 319 may detect objects within the images and include an interactive element for each object in the user interface. For example, the scanning subsystem 319 may create an interactive element for each object that is shaped like the object and overlay interactive elements over their respective objects in the user interface. In some embodiments, the scanning subsystem 319 may receive a selection of multiple objects via the interactive elements and create the bounding volume to encompass all of the multiple objects or a bounding volume for each object. The scanning subsystem 319 may determine the desired path based on the bounding volume(s). for multiple bounding volumes, the scanning subsystem 319 may create the desired path to traverse around each bounding volume such that the client device 310 may capture images of the objects in the bounding volume from every angle possible from traversable ground around the bounding volume.

In some embodiments, the feedback mechanisms include one or more of audio indicators, visual indicia, and haptic guidance. Audio indicators may include verbal alerts, verbal prompts, beeps, tones, chimes, and melodies. The visual indicia may be overlaid in a user interface that includes images captured as the user scans the object and may include arrows pointing in a direction, arrows angling at an orientation, and icons or signage indicative of a distance, orientation, and speed for scanning. The visual indicia may be displayed in the user interface as AR content such that the visual indicia are located within a virtual world presented via the user interface. The haptic guidance may include vibrations that may vary with intensity and pattern, force, torque, or motion effects, tactile feedback that create a sense of textures, rhythms, or patterns, heating, cooling, kinaesthetic feedback that causes the user to experience movement or resistance, and electric stimulation.

The scanning subsystem 319 may update the feedback mechanisms during scanning based on new sensor data received from the client device 310 describing a metric of the client device 310. In some embodiments, the metric is one of a set of scanning variables (e.g., the metrics) determined based on the sensor data, and the scanning variables include one or more of a distance between a camera of the mobile device and the object, an orientation of the camera, and a speed of the camera. In response to determining that none of the scanning variables are out of range based on the sensor data, the scanning subsystem 319 may provide a positive feedback mechanism, such as a melody or chime. In response to determining that one of the scanning variables is out of range, the scanning subsystem 319 may provide a negative feedback mechanism, such as intense vibrations or a blaring alarm sound.

### Example Computing System

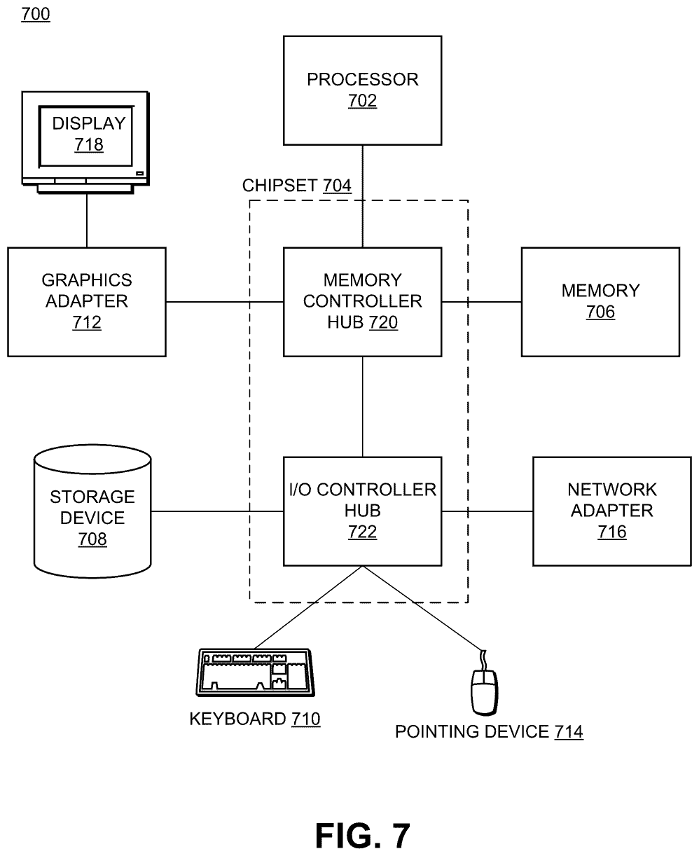

FIG. 7 is a block diagram of an example computer 700 suitable for use as a client device 310 or game server 320. The example computer 700 includes at least one processor 702 coupled to a chipset 704. References to a processor (or any other component of the computer 700) should be understood to refer to any one such component or combination of such components working cooperatively to provide the described functionality. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

In the embodiment shown in FIG. 7, the storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, touchscreen, or other type of pointing device, and may be used in combination with the keyboard 710 (which may be an on-screen keyboard) to input data into the computer system 700. The graphics adapter 712 displays images and other information on the display 718. The network adapter 716 couples the computer system 700 to one or more computer networks, such as network 370.

The types of computers used by the entities of FIGS. 3 and 4 can vary depending upon the embodiment and the processing power required by the entity. For example, the game server 320 might include multiple blade servers working together to provide the functionality described. Furthermore, the computers can lack some of the components described above, such as keyboards 710, graphics adapters 712, and displays 718.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method of scanning an object, the method comprising:
obtaining, from a mobile device, one or more images depicting the object;
estimating a bounding volume for the object based on the one or more images;
providing, to the mobile device, guidance regarding motion of the mobile device based the bounding volume;
receiving movement data describing motion of the mobile device;
determining that at least one scanning variable is out of range based on the movement data;
providing a first feedback mechanism indicative of a remedial motion; and
responsive to determining that the mobile device performed the remedial motion, providing a second feedback mechanism.

2. The computer-implemented method of claim 1, further comprising:
receiving one or more additional images depicting the object; and
updating the bounding volume for the object based on the additional images, wherein the guidance regarding the motion of the mobile device is based on the updated bounding volume.

3. The computer-implemented method of claim 1, further comprising:
providing, to the mobile device, a user interface including at least some of the one or more images; and
receiving, via an interactive element of the user interface, a selection of the object depicted in the one or more images.

4. The computer-implemented method of claim 1, further comprising:
providing, to the mobile device, a user interface including at least some of the one or more images; and
receiving, via an interactive element of the user interface, a selection of a set of objects depicted in the one or more images,
wherein the bounding volume is estimated based on the set of objects.

5. The computer-implemented method of claim 1, wherein the first feedback mechanism includes one or more of audio indicators, visual indicia, or haptic guidance.

6. The computer-implemented method of claim 1, wherein the scanning variable is one of a set of scanning variables determined based on the movement data and the scanning variables include one or more of a distance between a camera of the mobile device and the object, an orientation of the camera, or a speed of the camera.

7. The computer-implemented method of claim 1, further comprising:
in response to determining that none of a set of scanning variables are out of range based on the movement data, providing the second feedback mechanism.

8. The computer-implemented method of claim 1, wherein providing, to the mobile device, guidance regarding motion of the mobile device based on the bounding volume comprises:
providing instructions at a user interface of the mobile device to move the mobile device around the object from at least a threshold distance; and
responsive to determining that the mobile device is closer than the threshold distance to the object based on the movement data, providing the first feedback mechanism.

9. The computer-implemented method of claim 1, wherein determining that at least one scanning variable is out of range based on the movement data comprises determining that the mobile device is not located on a path around the object, the path determined based on the bounding volume.

10. The computer-implemented method of claim 1, wherein providing, to the mobile device, guidance regarding motion of the mobile device based the bounding volume comprises causing the mobile device to display the one or more images with an augmented reality track overlaid on the one or more images, the augmented reality track determined based on the bounding volume.

11. The computer-implemented method of claim 1, further comprising:
receiving a completed scan of the object; and
presenting a virtual element associated with the scan in a virtual environment displayed at a user interface of the mobile device.

12. A non-transitory, computer-readable medium storing instructions that, when executed by a computing system, cause the computing system to perform operations comprising:
obtaining, from a mobile device, one or more images depicting an object;
estimating a bounding volume for the object based on the one or more images;
providing, to the mobile device, guidance regarding motion of the mobile device based the bounding volume;
receiving movement data describing motion of the mobile device;
determining that at least one scanning variable is out of range based on the movement data;
providing a first feedback mechanism indicative of a remedial motion; and
responsive to determining that the mobile device performed the remedial motion, providing a second feedback mechanism.

13. The non-transitory, computer-readable medium of claim 12, the operations further comprising:
receiving one or more additional images depicting the object; and
updating the bounding volume for the object based on the additional images, wherein the guidance regarding the motion of the mobile device is based on the updated bounding volume.

14. The non-transitory, computer-readable medium of claim 12, the operations further comprising:
providing, to the mobile device, a user interface including at least some of the one or more images; and
receiving, via an interactive element of the user interface, a selection of the object depicted in the one or more images.

15. The non-transitory, computer-readable medium of claim 12, the operations further comprising:
providing, to the mobile device, a user interface including at least some of the one or more images; and
receiving, via an interactive element of the user interface, a selection of a set of objects depicted in the one or more images,
wherein the bounding volume is estimated based on the set of objects.

16. The non-transitory, computer-readable medium of claim 12, wherein the first feedback mechanism includes one or more of audio indicators, visual indicia, or haptic guidance.

17. The non-transitory, computer-readable medium of claim 12, wherein the scanning variable is one of a set of scanning variables determined based on the movement data and the scanning variables include one or more of a distance between a camera of the mobile device and the object, an orientation of the camera, or a speed of the camera.

18. The non-transitory, computer-readable medium of claim 12, the operations further comprising:
in response to determining that none of a set of scanning variables are out of range based on the movement data, providing the second feedback mechanism.

19. The non-transitory, computer-readable medium of claim 12, wherein providing, to the mobile device, guidance regarding motion of the mobile device based on the bounding volume comprises:
providing instructions at a user interface of the mobile device to move the mobile device around the object from at least a threshold distance; and
responsive to determining that the mobile device is closer than the threshold distance to the object based on the movement data, providing the first feedback mechanism.

20. The non-transitory, computer-readable medium of claim 12, wherein determining that at least one scanning variable is out of range based on the movement data comprises determining that the mobile device is not located on a path around the object, the path determined based on the bounding volume.
